(19) United States
(12) Patent Application Publication
(10) Pub. No.: US 2012/0049631 A1
(43) Pub. Date: Mar. 1, 2012

(54) POWER SUPPLY SYSTEM AND METHOD FOR ELECTRONIC APPARATUS

(75) Inventors: HAO-CHUN CHEN, Tu-Cheng (TW); I-CHUN YANG, Tu-Cheng (TW); YAO-TING WU, Tu-Cheng (TW); YAO-TUNG KUO, Tu-Cheng (TW)

(73) Assignee: HON HAI PRECISION INDUSTRY CO., LTD., Tu-Cheng (TW)

(21) Appl. No.: 13/110,086

(22) Filed: May 18, 2011

(30) Foreign Application Priority Data
Aug. 26, 2010 (CN) 201010263649.4

(51) Int. Cl. H02J 9/00; H02J 7/00

(52) U.S. Cl. 307/66

(57) ABSTRACT

A power supply system includes an adapter adapted to covert AC power into DC power, a power supply chipset connected to the adapter, a main battery, a slave battery, and a control chipset connected to the power supply chipset, the main battery, and the slave battery. The power supply chipset is adapted to receive DC power provided by the adapter. The control chipset is configured to monitor whether the power supply chipset receives DC power. The power supply chipset can provide DC power to the electronic device system and charge the main battery and the slave battery when the power supply chipset receives DC power. The power supply chipset also can control the main battery and the slave battery providing power to the electronic device system when the power supply chipset does not receive DC power.

### BACKGROUND

1. Technical Field

The present disclosure relates to electronic apparatus, and particularly to a power supply system and method for electronic apparatuses

2. Description of Related Art

Generally, a portable computer attached comes equipped with a battery for providing power to the portable computer. However, the battery is often easily depleted, which prevents the use of the portable computer for an extended period of time. To solve this problem, a user would have to carry an additional backup battery to replace the one in the computer when it is depleted. This method requires shutting down the computer, which can be time consuming, and it is inconvenient to carry an additional battery.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a power supply system for an electronic apparatus.

FIGS. 2-3 is a flowchart of an embodiment of a power supply method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

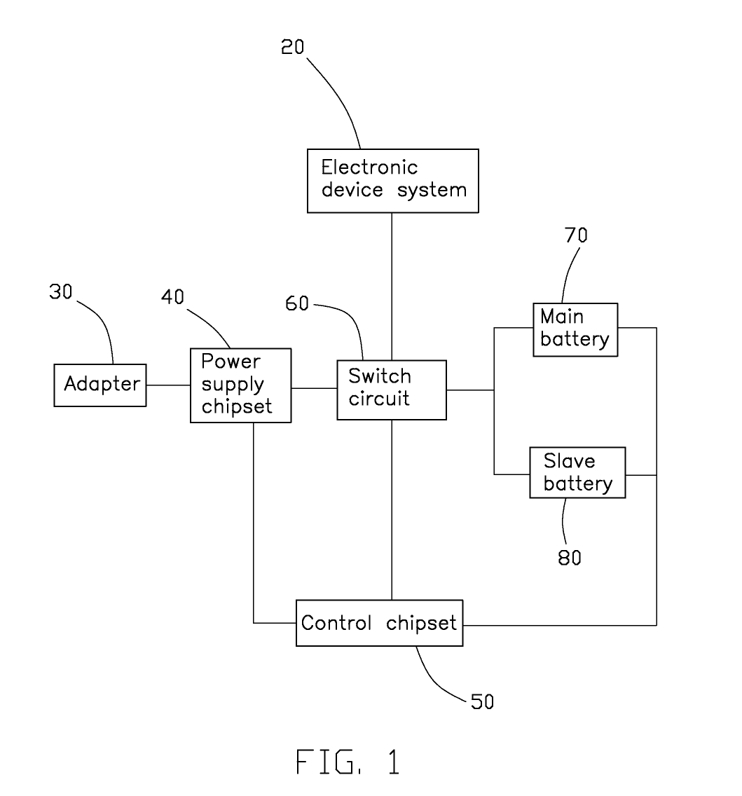

Referring to FIG. 1, a power supply system for an electronic apparatus in accordance with an embodiment, includes a electronic device system 20, an adapter 30, a power supply chipset 40, a control chipset 50, a switch circuit 60, a main battery 70, and a slave battery 80.

The adapter 30 is connected to the power supply chipset 40. The power supply chipset 40 is connected to the switch circuit 60. The switch circuit 60 is connected to the electronic device system 20, the control chipset 50, the main battery 70, and the slave battery 80. The control chipset 50 is connected to the power supply chipset 40, the switch circuit 60, the main battery 70, and the slave battery 80.

The adapter 30 is used to connect AC (alternating current) power, and converts the AC power into DC (direct current) power. The power supply chipset 40 receives the DC power, and provides the DC power to the switch circuit 60. The control chipset 50 controls the switch circuit 60 to turn on or off according to status of the main battery 70, slave battery 80, and the power supply chipset 40. For example, when the adapter 30 is connected to AC power, the control chipset 50 measures the power supply chipset 40 receiving DC power and controls the switch circuit 60 connected to the power supply chipset 40 to connect to the electronic device system 20. Thus, power supply chipset 40 provides the DC power to the electronic device system 20. Simultaneously, the control chipset 50 also measures the charge level of the main battery 70 and the slave battery 80. If the main battery 70 or the slave battery 80 is not full, the control chipset 50 will control the switch circuit 60 to connect the power supply chipset 40 to the main battery 70 or the slave battery 80 to charge the main battery 70 or the slave battery 80. If the main battery 70 and the slave battery 80 are full, the control chipset 50 will control the switch circuit 60 to disconnect the power supply chipset 40 from the main battery 70 or the slave battery 80. Alternatively, when the adapter is not connected to AC power, the control chipset 50 measures the power supply chipset 40 not receiving DC power; the control chipset 50 controls the switch circuit 60 to disconnect the power supply chipset 40 to the electronic device system 20, and controls the switch circuit 60 to connect the main battery 70 or slave battery 80 to the electronic device system 20. Therefore, the main battery 70 or slave battery 80 provides power to the electronic device system 20.

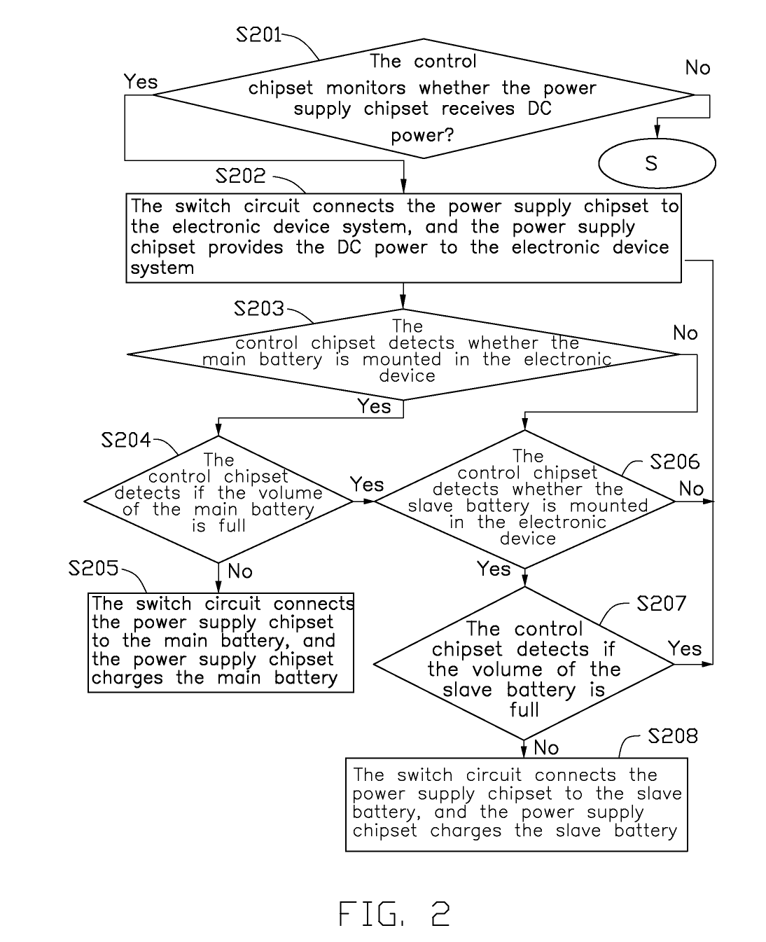

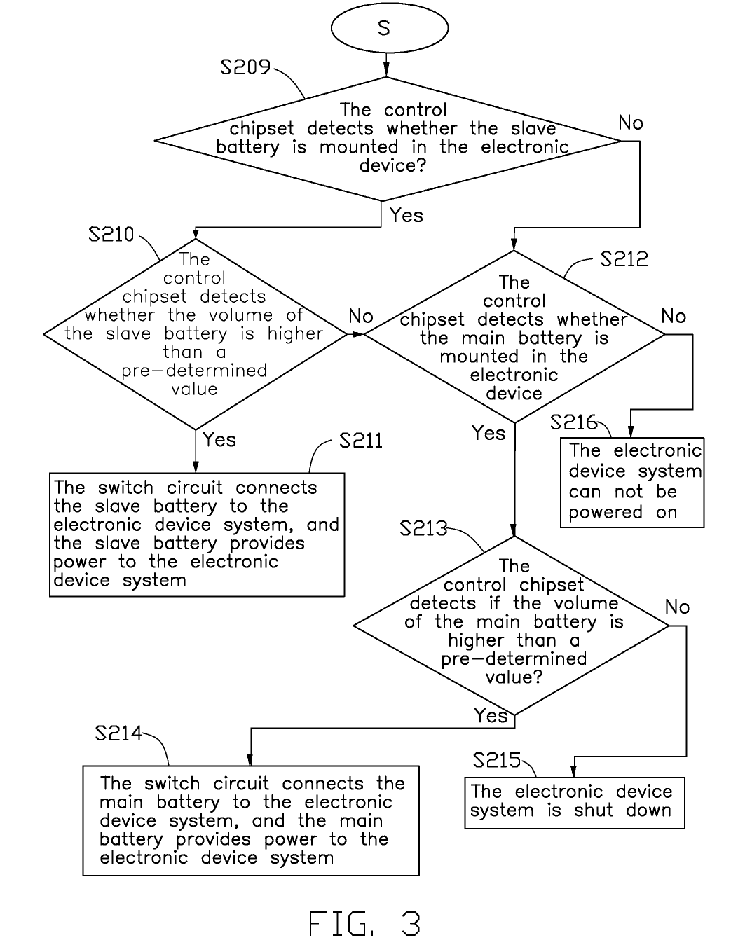

Referring to FIGS. 2 and 3, an embodiment of a method for providing power to the electronic device system 20 is shown as follows.

In step S201, the control chipset 50 monitors whether the power supply chipset 40 receives DC power. If the power supply chipset receives DC power, go to step S202; and if the power supply chipset 40 does not receives DC power, go to step S209.

In step S202, the switch circuit 60 connects the power supply chipset 40 to the electronic device system 20, and the power supply chipset 40 provides the DC power to the electronic device system 20.

In step S203, the control chipset 50 measures whether the main battery 70 is attached to the electronic device. If the main battery 70 is attached, go to step S204, and if the main battery 70 is not attached, go to step S206.

In step S204, the control chipset 50 measures the charge level of the main battery 70. If the charge level of the main battery 70 is full, go to step S206, and if the charge level of the main battery 70 is not full, go to step S205.

In step S205, the switch circuit 60 connects the power supply chipset 40 to the main battery 70, and the power supply chipset 40 charges the main battery 70.

In step S206, the control chipset 50 measures whether the slave battery 80 is attached to the electronic device. If it is determined the slave battery 80 is attached, go to step S207, and if the slave battery 80 is not attached, go back to step S202.

In step S207, the control chipset 50 measures the charge level of the slave battery 80. If the charge level of the slave battery 80 is full, go to step S202, and if the charge level of the slave battery 80 is not full, go to step S208.

In step S208, the switch circuit 60 connects the power supply chipset 40 to the slave battery 80, and the power supply chipset 40 charges the slave battery 80.

In step S209, the control chipset 50 measures whether the slave battery 80 is attached to the electronic device. If the slave battery 80 is attached, go to step S210, and if the slave battery 80 is not attached, go to step S212.

In step S210, the control chipset 50 measures charge level of the slave battery 80. If the charge level of the slave battery 80 is higher than a pre-determined value, go the step S211, and if not, go to step S212.

In step S211, the switch circuit 60 connects the slave battery 80 to the electronic device system 20, and the slave battery 80 provides power to the electronic device system 20.

In step S212, the control chipset 50 measures whether the main battery 70 is attached in the electronic device. If the main battery 70 is attached, go to step S213, and if the main battery 70 is not attached, go to step S216.

In step S213, the control chipset 50 measures the charge level of the main battery 70. If the charge level of the main battery 70 is higher than a pre-determined value, go the step S214, and if not, go to step S215.

In step S214, the switch circuit 60 connects the main battery 70 to the electronic device system 20, and the main battery 70 provides power to the electronic device system 20.

In step S215, the electronic device system 20 is shut down.

In step S216, the electronic device system 20 cannot be powered on.

In one embodiment, both of the main battery 70 and slave battery 80 can be attached in the electronic device. When the slave battery 80 is powered off, the main battery 70 automatically continues to provide power to the electronic device system 20, which avoids detaching the slave battery 80, and re-attaching the main battery 70.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed. Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A power supply system comprising:
an adapter adapted to covert AC power into DC power;
a power supply chipset connected to the adapter, the power supply chipset adapted to receive DC power provided by the adapter;
a main battery and a slave battery; and
a control chipset connected to the power supply chipset, the main battery, and the slave battery;
wherein the control chipset is adapted to monitor whether the power supply chipset receives DC power, the control chipset is adapted to provide DC power to an electronic device system and charge the main battery and the slave battery when the power supply chipset receives DC power, and the control chipset is also adapted to control the main battery and the slave battery providing power to the electronic device system when the power supply chipset do not receive DC power.

2. The power supply system of claim 1, further comprising a switch circuit, wherein the switch circuit is connected to the power supply chipset, the electronic device system, the main battery, and the slave battery; and the switch circuit is controlled by the control chipset.

3. The power supply system of claim 1, wherein the control chipset is adapted to cause the power supply chipset to charge the main battery when the main battery is not full and to charge the slave battery when the main battery is full.

4. The power supply system of claim 1, wherein the control chipset is adapted to cause the main battery to provide power to the electronic device system when the slave battery is empty, and the control chipset is adapted to cause the slave battery to provide power to the electronic device system when the slave battery is not empty.

5. A method for providing power to an electronic device system of an electronic device, comprising:
determining whether an adapter of the electronic device is supplied with AC power;
when in the presence of AC power, converting AC power into DC power by the adapter, and directing DC power to the electronic device system;
when there is no AC power, providing power to the electronic device from a slave battery and a main battery.

6. The method of providing power of claim 5, wherein the providing power to the electronic device system from the slave battery and the main battery further comprises determining whether the slave battery is empty; when the slave battery is not empty, providing power to the electronic device system from the slave battery; and when the slave battery is empty, providing power to the electronic device system from the main battery.

7. The method of providing power of claim 6, wherein if the main battery is empty, the electronic device is shut down.

8. The method of providing power of claim 5, wherein the converting AC power into DC power further comprises determining whether the main battery is full; when the main battery is not full, DC power is provided to the main battery to charge the main battery.

9. The method of providing power of claim 6, wherein determining whether the main battery is full further comprises determining whether the salve battery is full; when the slave battery is not full, DC power is provided to the slave battery to charge the slave battery.

10. A method for providing power to an electronic device system of an electronic device, comprising:
providing a control chipset, an adapter, a salve battery and a main battery;
determining whether the adapter is supplied with AC power by the control chipset;
when in the presence of AC power, converting AC power into DC power by the adapter, and directing DC power to the electronic device system;
when there is no AC power, providing power to the electronic device from the slave battery and the main battery.
